(19) United States
(12) Patent Application Publication
(10) Pub. No.: US 2008/0076344 A1
(43) Pub. Date: Mar. 27, 2008

(54) ACOUSTIC BODY EXHAUSTER

(76) Inventor: RANDALL B. FLOWERDAY, Milford, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/765,706

(22) Filed: Jun. 20, 2007

Related U.S. Application Data
(60) Provisional application No. 60/805,237, filed on Jun. 20, 2006.

(51) Int. Cl. B60H 1/24

(52) U.S. Cl. 454/162; 454/906

(57) ABSTRACT

A body exhauster includes a housing defining an opening, at least one louver rotatably supported by the housing, and a sound-absorbing material attached to and extending from the housing to prevent noise from traveling through the housing.

### FIELD OF THE INVENTION

The present invention relates to a body exhauster of a vehicle, and more particularly, to an improved body exhauster attenuating road noise created through movement of the vehicle.

### BACKGROUND OF THE INVENTION

Automotive vehicles typically include at least one body exhauster that provides fluid communication between an interior compartment of the vehicle and an area outside of the vehicle (i.e., atmosphere). Conventional body exhausters typically include a frame housing at least one moveable vein or louver that allows movement of air in one direction through the housing. Typically, movement of air through the housing is permitted between the interior of the vehicle and the exterior of the vehicle to allow proper performance of a heating ventilation and air conditioning (HVAC) unit of the vehicle and to improve operation of closure panels (i.e., doors, trunks, windows, etc.) by allowing displaced air caused by a moving closure panel or forced air from the HVAC unit to escape the interior compartment.

Conventional body exhausters may be positioned within a body panel of a vehicle such as a front or rear quarter panel. Because placement of the body exhausters in a quarter panel of the vehicle typically results in the body exhauster being placed in close proximity to a wheel of the vehicle, road noise caused by movement of the wheels over a road surface is permitted to enter the interior compartment through the housing of the body exhauster. Such noise is typically adverse to passengers located within the interior compartment and must be treated by placement of sound-absorption materials on interior trim panels and components, which results in heavier, more complex, and more costly interior trim and related components. While such sound-absorption material adequately absorbs noise received through the body exhauster, some of the noise associated with the moving wheels and operation of the vehicle is still received within the interior compartment of the vehicle through the open louvers of the body exhauster.

### SUMMARY OF THE INVENTION

A body exhauster includes a housing defining an opening, at least one louver rotatably supported by the housing, and a sound-absorbing material attached to and extending from the housing to prevent noise from traveling through the housing.

### BRIEF DESCRIPTION OF THE DRAWINGS

The present invention will become more fully understood from the detailed description and the accompanying drawings, wherein:

FIG. 1 is a perspective view of a body exhauster incorporating a sound-absorption device in accordance with the principals of the present invention;

FIG. 2 is a perspective view of a body panel incorporating the body exhauster and sound-absorption device of FIG. 1 in accordance with the principals of the present invention;

FIG. 3 is a perspective view of a body panel and side aperture panel incorporating the body exhauster and sound-absorption device of FIG. 1 in accordance with the principals of the present invention;

FIG. 4 is a rear view of the body panel and side aperture panel of FIG. 4 incorporating the body exhauster and sound-absorption device of FIG. 1 in accordance with the principals of the present invention;

FIG. 5 is a perspective view of the body exhauster of FIG. 1 incorporating another sound-absorption device in accordance with the principals of the present invention; and

FIG. 6 is a side view of the body exhauster and sound-absorption device of FIG. 5 incorporated into a body panel in accordance with the principals of the present invention.

### DETAILED DESCRIPTION OF THE PREFERRED EMBODIMENTS

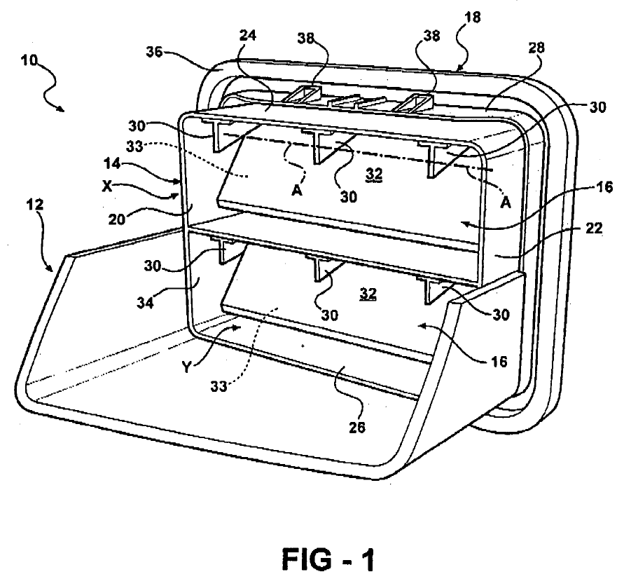

With reference to FIG. 1, a body exhauster 10 incorporating a sound-absorption device 12 is provided. The sound-absorption device 12 is disposed adjacent to the body exhauster 10 such that noise generally surrounding the body exhauster 10 is absorbed by the sound-absorption device 12 prior to the noise reaching and passing through the body exhauster 10.

The body exhauster 10 includes a housing 14, a series of louvers 16 rotatably supported by the housing 14, and an attachment mechanism 18 for attaching the housing 14 to an external structure. The housing 14 includes a generally rectangular shape defining a first-side member 20, a second-side member 22, a top member 24, and a bottom member 26. The first-side member 20 is generally parallel to the second-side member 22 while the top member 24 is generally parallel to the bottom member 28. Because the first and second-side members 20, 22 are generally parallel to one another and the top and bottom members 24, 26 are generally parallel to one another, the first-side member 20 is generally perpendicular to the top member 24 and the bottom member 28 while the second-side member 22 is similarly perpendicular to the top member 24 and the bottom member 26. Cooperation between the first-side member 20, second-side member 22, top member 24, and bottom member 26 provides the housing 14 with a generally rectangular shape. While the housing 14 is described as including a generally rectangular shape, the housing 14 may include any shape that permits the louvers 18 to rotate relative to the housing 14 between an open position and a closed position such as a square shape, an oval shape, or a round shape.

Each of the first-side member 20, second-side member 22, top member 24, and bottom member 28 extends from a base 28 of the housing 14 to define the overall depth of the body exhauster 10. The top member 24 includes a series of projections 30 that act as stops for selective engagement with the louvers 16 when the louvers 16 are in the open position. If the body exhauster 10 includes more than one louver 16, each louver 16 will have an associated top member 24 and bottom member 28. For example, as shown in FIG. 1, when louvers 16 are stacked, a bottom member 26 of a top louver assembly (X) will function both as the bottom member 28 of the top louver assembly (X) as well as the top member 24 of a bottom louver assembly (Y). As shown, each of the top lower assembly (X) and bottom louver assembly (Y) includes a rotatable louver 16 and associated first and second-side members 20, 22.

The louvers 16 are rotatably supported generally within the housing 14 and are rotatably attached to the first-side member 20 and the second-side member 22. Each louver 16 is rotatable about an axis (A) between an open position and closed position. When the louvers 16 are in the closed position, a surface 32 of each louver 16 is a generally perpendicular to the first-side member 20, second-side member 22, top member 24, and bottom member 26. When the louvers 16 are in the closed position, an opening 34 of the housing 14 is generally closed. Rotation of the louvers 16 into the open position is only permitted in one direction therefore flow through the housing 14 is restricted to a single direction.

When the louvers 16 are moved from the closed position to open position, the surface 32 of each louver 16 abuts the projections 30 of respective top members 24. In this position, the louvers 16 permit flow into the housing 14 through opening 34. The louvers 16 are biased into the closed position by the weight of each louver 16. When a force is applied to each louver 16 at a surface 33 opposite to surface 32, each louver 16 is caused to rotate about axis (A) until surface 32 contacts the projections 30 of respective top members 24. Once the surface 32 of each louver 16 engages the projections 30 of the top member 24, the louvers 16 are in the open position and flow through the housing 14 is permitted.

The force applied to each louver 16 may be caused by a rush of air engaging each louver 16 at surface 33. The louvers 16 will return to the closed position once the force applied to each louver 16 is stopped and are moved under the weight of each louver 16. Because the louvers 16 are only permitted to rotate in a single direction into the open position, a force applied to surface 32 of each louvers 16 will not cause the louvers 16 to rotate about axis (A) and into the open position. Rather, the louvers remain in the closed position and prevent flow through the housing 14.

With particular reference to FIG. 1, the attachment mechanism 18 is shown to include a ring 38 and a series of tabs 38 that cooperate to fixedly attach the body exhauster 10 to an external structure. The ring 36 receives the housing 14 or base 28 of the body exhauster 10 and properly positions and aligns the body exhauster 10. The tabs 38 may be integrally formed with the base 28 of the housing 14 and/or with any or all of the first-side member 20, second member 22, top member 24, and bottom member 26 and interact with the external structure to fixedly attach the body exhauster 10 there to. The tabs 38 may be snap fit into mating apertures (not shown) disposed within the external structure or may alternatively or additionally receive mechanical fasteners. While a series of tabs 38 are disclosed, any method for suitably attaching the body exhauster 10 to the external structure such as epoxy or other adhesive may be used in conjunction with or in place of the tabs 38.

With particular reference to FIG. 1, the sound-absorption device 12 is attached to the housing 14 of the body exhauster 10 proximate to opening 34. Attachment of the sound-absorption device 12 to the housing 14 may be accomplished by heat staking or sonic welding the sound-absorption device 12 to the housing 14. While heat staking and sonic welding are disclosed, any suitable method for fixedly attaching the sound-absorption device 12 to the housing 14 such as epoxy or mechanical fasteners may alternatively or additionally be used.

The sound-absorption device 12 is formed from a sound-attenuating material and is positioned near the bottom member 26 of the housing 14. The sound-absorption device 12 is shown as extending across the entire bottom member 26 of the housing 14 and at feast partially onto each of the first-side member 20 and second-side member 22. The sound-absorption device 12, while shown at feast partially extending onto first-side member 20 and second-side member 22, may alternatively be positioned solely on the bottom member 26, solely on the side-members 20, 22 or across the bottom member 26 and along the length of each side member 20, 22. The sound-absorption device 12 may also fully encircle the housing 14 such that the sound-absorption device 12 extends at least partially on each of the first-side member 20, second-side member 22, top member 24, and bottom member 26.

The exact positioning of the sound-absorption device 12 largely depends on the position of the body exhauster 10 relative to a source of noise. Generally speaking, the sound-absorption device 12 is positioned such that the sound-attenuating material is located between the body exhauster and the source of noise.

The sound-attenuating material should include properties that allow the sound-absorption device 12 to absorb noise generally surrounding the housing 14 to prevent the noise from traveling through the housing 14. The sound-attenuating material may be constructed of a flexible and/or water-shedding material such as, for example, a polyester fiber. The water-shedding nature of the sound-attenuating material allows the body exhauster 10 to he positioned on an external structure that may be subjected to the elements (i.e., water, ice, snow, etc.).

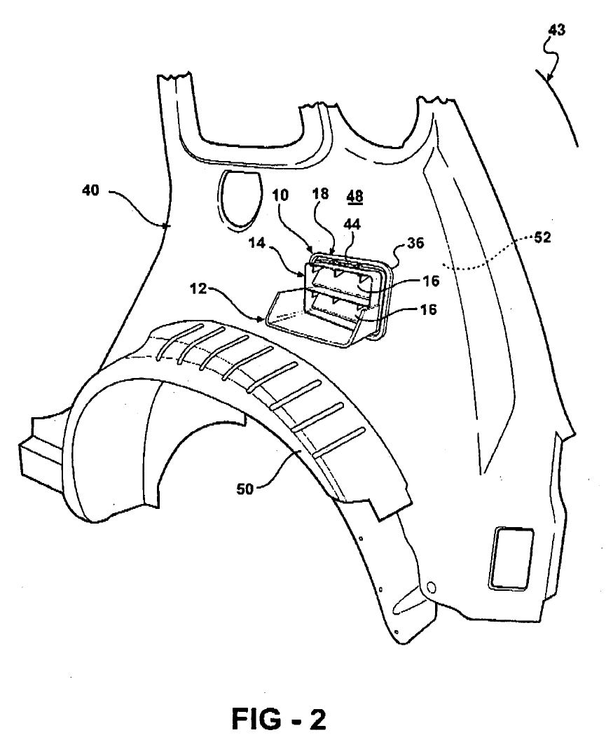

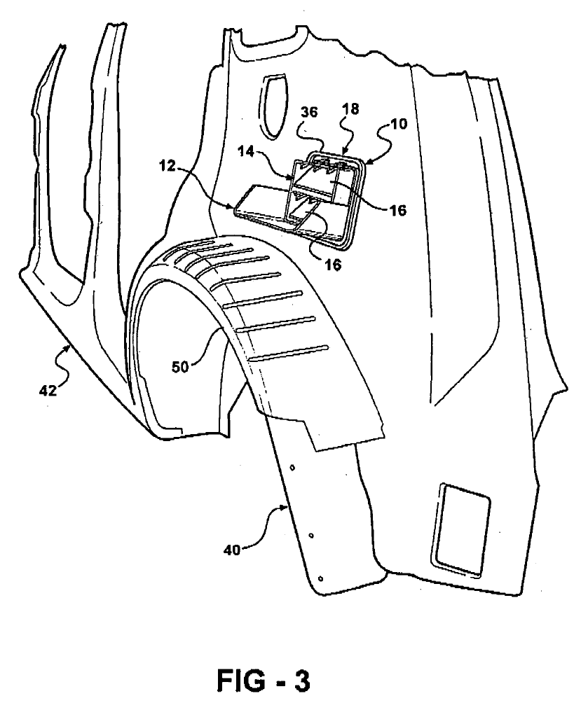

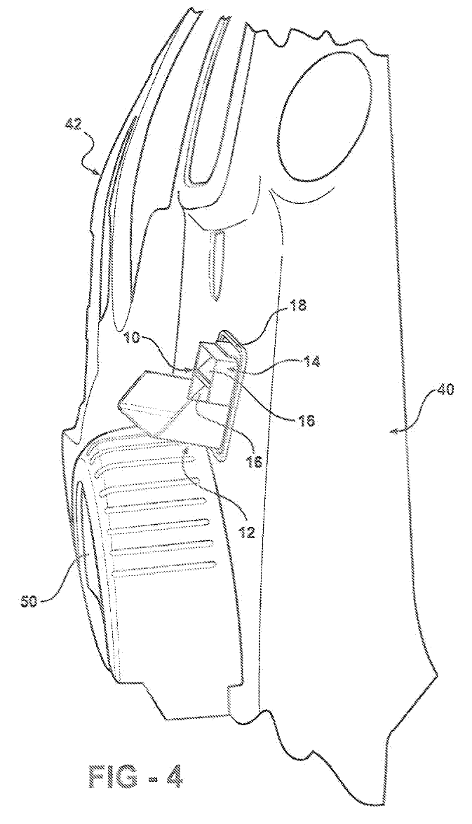

With particular reference to FIGS. 2 through 4, the body exhauster 10 and sound-absorption device 12 are shown incorporated into a body panel 40 and side aperture panel 42 of a vehicle 43. FIG. 2 shows the body panel 40 as including an opening 44 that matingly receives the base 28 of the housing 14. The ring 36 surrounds the opening 44 and helps position the housing 14 and base 28 relative to the opening 44. Once the housing 14 and base 28 are properly positioned within the opening 44, the tabs 38 may be snap-fit into mating apertures located on the body panel 40 and/or may receive fasteners (not shown) for fixedly attaching the housing 14 and base 28 to the body panel 40. Once the housing 14 and base 28 are attached to the body panel 40, the sound-absorption device 12 and housing 14 are positioned such that both the sound-absorption device and housing 14 extend away from a surface 48 of the body panel 40.

Because the sound-absorption device 12 is formed from a wafer-shedding material, the body exhauster 10 and sound-absorption device 12 may be positioned on the body panel 40 in a location that may be subjected to wet conditions such as ice, snow, and rain. For example, the body exhauster 10 and sound-absorption device 12 may be positioned above a wheel wall 50 of the body panel 40.

With continued reference to FIGS. 2-4, operation of the body exhauster 10 and sound-absorption device 12 will be described in detail. As described above, each of the louvers 16 is biased into the closed position and remains in the closed position until a sufficient force is applied to surface 33. When a sufficient force is applied to each louver 16, the louvers 16 rotate about axis (A) until surface 32 of each louver 16 contacts the projections 30 formed on each top member 24. Once surface 32 contacts the projections 30, the louvers 16 are prevented from further rotating relative to the housing 14. The louvers 16 remain in the open position until the force applied to each louver 16 is reduced to a point where the weight of each louver 16 is once again permitted to position each louver 16 into the closed position.

The sound-absorption device 12 may extend between the opening 34 of the housing 14 and the wheel well 50 of the body panel 40 such that noise associated with operation of a wheel (not shown) disposed within the wheel well 50 is prevented from reaching the opening 34 of the housing 14. By reducing noise caused by operation of the wheel and/or other related vehicle components from reaching the opening 34 of the housing 14, such noise is prevented from being transmitted through the housing 14 and into an interior compartment 52 of the vehicle 43. Preventing such noise from reaching the interior compartment 52 of the vehicle 43 enhances the enjoyment and ride for occupants disposed within the interior compartment 52.

Because the sound-absorption device 12 is disposed around a perimeter of the housing 14, rotation of each louver 16 relative to the housing 14 is not restricted. Therefore, if a force is applied to each louver 16 such as, for example, by a rush of air entering the interior compartment 52 of the vehicle 43, each louver 16 is permitted to rotate relative to the housing 14 without contacting the sound-absorption device 12. The rush of air may be exhausted from the interior compartment 52 through the housing 14 simply by allowing the louvers 16 to freely rotate relative to the housing 14 once subjective to a predetermined force at surface 33.

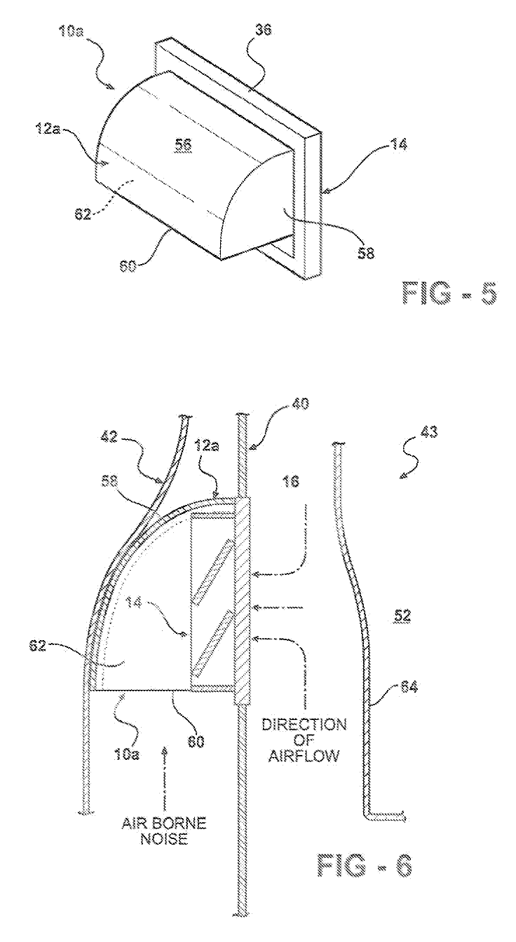

With particular reference to FIGS. 5 and 6, a body exhauster 10a is provided. In view of the substantial similarity in structure and functions of the components associated with the body exhauster 10 and the body exhauster 10a, like reference numerals are used here and after and the drawings to identify like components, while like reference numerals containing letter extensions are used to identify those components that have been modified.

The sound-absorption device 12a includes an arcuate surface 56 extending from the top member 24 of the housing 14 and two side panels 58 respectively attached to the first side member 20 and second-side member 22 of the housing 14. Each of the arcuate surface 56 and side panels 58 are formed of a sound-attenuating material such that any ambient noise received near the opening 34 of the housing 14 is absorbed by the sound-absorption device 12. As noted above with respect to the sound-absorption device 12, the sound-absorption device 12a may be positioned on a body panel 40 or side aperture panel 42 in a location where the body exhauster 10 and/or sound-absorption device 12 may be exposed to wet conditions. Therefore, the sound-absorption device 12 may be formed of a water-shedding material such as a polyester fiber. As with the sound-absorption device 12, the sound-absorption device 12a may be similarly heat staked or sonic welded to the housing 14.

The sound-absorption device 12a is positioned between the side aperture panel 42 and body panel 40 such that an opening 60 of the sound-absorption device generally opposes the wheel well 50. Because the opening 60 faces the wheel well 50, noise generated by movement of a wheel within the well and/or movement of the vehicle 43 is directed to the opening 60 and is received within an interior space 62 of the sound-absorption device 12a.

Once the noise is collected within the interior space 62, the noise attenuating material of the sound-absorption device 12a absorbs the noise prior to the noise reaching the housing 14. Specifically, the material of the sound-absorption device 12a cooperates with the arcuate surface 56 to both absorb the noise and also to direct the noise away from the opening 34 of the housing 14, thereby preventing the noise from traveling through the housing 14 and reaching the interior compartment 52 of the vehicle 43.

As shown in FIG. 6, the vehicle 43 may include a trim component 64 disposed between the body panel 40 and the interior compartment 52 of the vehicle 43. If the vehicle 43 includes, an interior trim component 64 disposed between the body panel 40 and the inferior compartment 52, the interior trim component 64 may include sound-attenuating material to absorb any noise passing through the housing 14 prior to the noise reaching the interior compartment 52. While the interior trim component 64 is shown in association with the sound-absorption device 12a, the interior trim component 64 may similarly be used with the sound-absorption device 12.

What is claimed is:

1. A body exhauster comprising:
a housing defining an opening;
at least one louver rotatively supported by said housing; and
a sound-absorbing material attached to and extending from said housing to prevent noise from traveling through said housing.

2. The body exhauster of claim 1, wherein said housing includes a first-side member parallel to a second-side member and a top member parallel to a bottom member.

3. The body exhauster of claim 2, wherein said first-side member and said second-side member are perpendicular to said top member and said bottom member.

4. The body exhauster of claim 2, wherein said sound-absorbing material comprises an upper portion extending in an arcuate configuration from said housing top member, and two side portions extending outwardly from said respective first and second housing side members to said upper portion.

5. The body exhauster of claim 2, wherein said sound-absorbing material, extends along a length of said bottom member.

6. The body exhauster of claim 5, wherein said sound-absorbing material extends at least partially onto said first-side member and said second-side member.

7. The body exhauster of claim 1, wherein said sound-absorbing material is formed from a water-shedding material.

8. The body exhauster of claim 7, wherein said water-shedding material comprises a polyester fiber material.

9. The body exhauster of claim 1, wherein said sound-absorbing material is at least one of heat staked or sonic welded to said housing.

10. The body exhauster of claim 1, wherein said sound-absorbing material is formed from a flexible material.

11. The body exhauster of claim 1, wherein said at least one louver comprises two louvers.
